(19) United States
(12) Patent Application Publication
(10) Pub. No.: US 2009/0177502 A1
(43) Pub. Date: Jul. 9, 2009

(54) System for matching drivers with customers seeking to hire a driver

(76) Inventors: Nick Doinoff, North Lima, OH (US); Theresa Doinoff, North Lima, OH (US); Tony Bell, Poland, OH (US); Ursula Bell, Poland, OH (US)

Correspondence Address: BACON & THOMAS, PLLC, 625 SLATERS LANE, FOURTH FLOOR, ALEXANDRIA, VA, 22314-1176, US

(21) Appl. No.: 12/007,183

(22) Filed: Jan. 8, 2008

(51) Int. Cl. G06Q 10/00

(52) U.S. Cl. 705/5

(57) ABSTRACT

A server computer is programmed or adapted to register drivers and customers. Registered customers log into the system and generate booking inquiries which are received by the system. In response to a booking inquiry, the system searches among registered drivers for available drivers corresponding to the request and presents to the customer a list of available drivers. The system may receive a booking request selecting one of the available drivers for hire. The booking request is added to a booking request list for the selected driver, and a voice message is generated and forwarded to the selected driver indicating receipt of the booking request and alerting the selected driver to log in to the system to review new booking requests. When a driver logs in to the system, a list of pending booking requests is provided, allowing the driver to accept or decline any of the pending booking requests.

### FIELD OF THE INVENTION

The present invention relates to a system and method to match a service provider with a customer, and more particularly a system and method to match a vehicle driver for hire with a customer having a transportation need and desiring a driver.

### BACKGROUND

Vehicular transportation has become a necessity for many individuals, whether for business, recreation, or simply attending to the many errands attendant to every day life.

Of course, many individuals attend to their own vehicular transportation needs by owning and driving their own motor vehicle, or driving a motor vehicle which is owned by a family member, rented, borrowed from a friend or the like.

Certain individuals, however, may rely on, or benefit from, transportation services provided by another person. For example, many individuals fulfill their transportation needs with the services of a privately hired vehicle and driver (such as a taxicab, limousine service, or the like) or through public transportation such as a bus or other mass transit service.

Still others may desire, on occasion, to obtain the services of a hired driver to provide driving services, using the individual's own vehicle.

One example relates to a serious nationwide problem of drinking and driving. Alcohol consumption is well known to impair an individual's judgment and ability to drive.

Individuals who have driven themselves to a location or an event, such as bar, a party, or the like, where alcoholic beverages will be consumed, may become impaired. Designated driver programs have been employed wherein a taxi is provided to transport the impaired individual home, leaving the individual's vehicle to be retrieved later. Individuals may decline to participate in such programs, however, if they must leave their vehicle in an unattended and unsecured location until it can be retrieved. Also, the individual may lack an alternative means of transportation needed to retrieve their vehicle.

Other programs have been employed where a driver for hire is contacted to drive the individual in the individual's vehicle home. However, such an arrangement may require an additional “chase vehicle” and driver to pick up the hired driver upon completion of a trip.

Such programs, however, typically are provided for individuals who have already become impaired, without the benefit of advance planning.

Since an individual's judgment may become impaired along with the individual's driving ability, once an individual has become intoxicated or impaired the individual may simply lack the judgment to obtain assistance, unless an arrangement has been made in advance.

Services have been provided wherein a driver may be contacted and hired to transport an individual and their vehicle home, should the individual have become intoxicated or simply wish to avoid the risk of a traffic stop or arrest for driving while intoxicated.

In another example, individuals, including elderly, sick or infirm persons, may wish to obtain the services of a driver for transportation to and from a medical appointment, for personal errands, or for any of a broad range of transportation needs. Individuals who own a vehicle may be prefer to use their own vehicle for these trips, finding their own vehicle to be more comfortable and more convenient than a hired vehicle.

The Internet provides a widely used and convenient medium for communication among individuals and service providers. Accordingly, Internet services have been created for matching individual consumers with individual service providers.

For example, Internet, or Wide World Web (Web), companies like eBay Inc. of San Jose, Calif., provide a forum whereby purchasers of goods and consumers are brought together in Web-space to conduct business transactions.

An affordable and convenient alternative for fulfilling an individual's transportation needs is desired, wherein a forum is provided for individuals seeking to hire a driver to identify and communicate with drivers offering their services.

Further, it is desirable in such a forum that drivers are systematically vetted or screened according to their qualifications, and communication of individual service requests to drivers (as well as driver response to the service requests) is facilitated to enhance a customer/driver relationship.

### SUMMARY

A system for matching drivers with customers seeking to hire a driver facilitates contact between a customer and a driver, wherein a customer typically (although not necessarily) is an individual having a vehicle, and desiring to hire a driver to drive the individual in the individual's vehicle on one or more vehicle trips.

A system operator may operate the system for revenue, by imposing booking and other service fees, by setting driver billing and compensation rates, or other methods.

According to one aspect of the system, a server computer is provided in communication with a communication interface whereby the server computer is accessible by at least one user terminal, and a system data store configured for storing user data including a plurality of driver profiles and a plurality of customer profiles is provided in communication with the server computer.

The server computer is configured to receive customer booking inquiries from customer, determine and deliver to a customer a list of available drivers corresponding to a booking inquiry, receive from the customer a booking request selecting one of the available drivers, add the booking request to a pending booking request list for the selected driver, and generate and forward to the selected driver a voice message indicating receipt of the booking request.

The voice message (for example delivered to the driver's telephone) serves as an alert or a reminder to the driver to access the system to view a list of booking requests pending for the driver. Accordingly, the driver is prompted to timely access his pending request list and review new booking requests without the need for the driver to regularly access the system to check for new booking requests.

According to another aspect of the invention, the system is configured to deliver to a customer a driver profile, including a driver video viewable by the customer. Thus, a driver may create a video presentation which a customer may use to evaluate the driver (in consideration of the driver's appearance, mannerisms, and other characteristics that may be well presented in a video format) in making a hiring decision.

According to a further aspect of the invention, the system is configured to deliver a pending booking request list to a driver (typically, once the driver logs in to the system), and to receive from the driver an indication of the driver's acceptance or refusal of any of the listed pending booking requests.

According to a still further aspect of the invention, the system is configured to deliver to a customer an indication of a driver's acceptance of a booking request, and to receive a booking confirmation from the customer to hire the driver.

These and other features, aspects, and advantages of the present invention will become better understood with regard to the following description, appended claims, and accompanying drawings.

### BRIEF DESCRIPTION OF THE DRAWINGS

FIG. 1 is a schematic block diagram of a computer system implementing a method for matching a driver to a customer.

FIG. 2 is diagrammatic illustration indicating basic customer and driver interactions with a system according to the present invention.

FIG. 3 is a screen image of a user home page which may be displayed upon a user's initial accession to the system.

FIG. 3 is a flowchart of a process for driver sign-in, registration, and functions in an embodiment of a system according to the present invention.

FIG. 5 is a screen image of a driver home page for a registered driver.

FIG. 6 is an embodiment of a driver information table showing driver information for a registered driver.

FIG. 7 is a screen image of an embodiment of a driver information entry form.

FIG. 8 is a screen image of an embodiment of a driver information entry form.

FIG. 9 is a screen image of an embodiment of a working area entry form.

FIG. 10 is a screen image of an embodiment of an editable driver availability calendar.

FIG. 11 is a screen image of an embodiment of a driver availability entry form.

FIG. 12 is a screen image of an embodiment of a displayed printable driver identification card.

FIG. 13 is a flowchart of a process for customer sign-in, registration, and functions.

FIG. 14 is a screen image of a customer home page for a registered customer.

FIG. 15 is an embodiment of a customer information table showing customer information for a registered customer.

FIG. 16 is a screen image of an embodiment of a customer information entry form.

FIG. 17 is a screen image of an embodiment of a driver request entry form.

FIG. 18 is a screen image of an embodiment of a driver instruction entry form.

FIG. 19 is a flowchart of a process for handling a customer booking inquiry, booking request, and acceptance, and confirmation.

FIG. 20 is a flowchart of a process for updating and servicing a telephone reminder table.

FIG. 21 is a screen image of an embodiment of a driver selection form.

FIG. 22 is a screen image of an embodiment of a driver profile display form.

FIG. 23 is a screen image of an embodiment of a driver availability display form.

FIG. 24 illustrates a booking request table.

FIG. 25 illustrates a pending reminder table.

FIG. 26 is a screen image of an embodiment of an entry form for administration of driver voice messaging.

FIG. 27 is a screen image of an embodiment of

FIG. 28 is a screen image of an embodiment of a payment option and entry form.

FIG. 29 is a block diagram of an embodiment of a computer device.

FIG. 30 is a block diagram of the server computer including computer program code for executing the method and functions of the system.

### DETAILED DESCRIPTION OF VARIOUS EMBODIMENTS

The present invention provides a system and method for matching customers in need of a vehicle driver with drivers, and for managing interaction and payment transactions between customers and drivers.

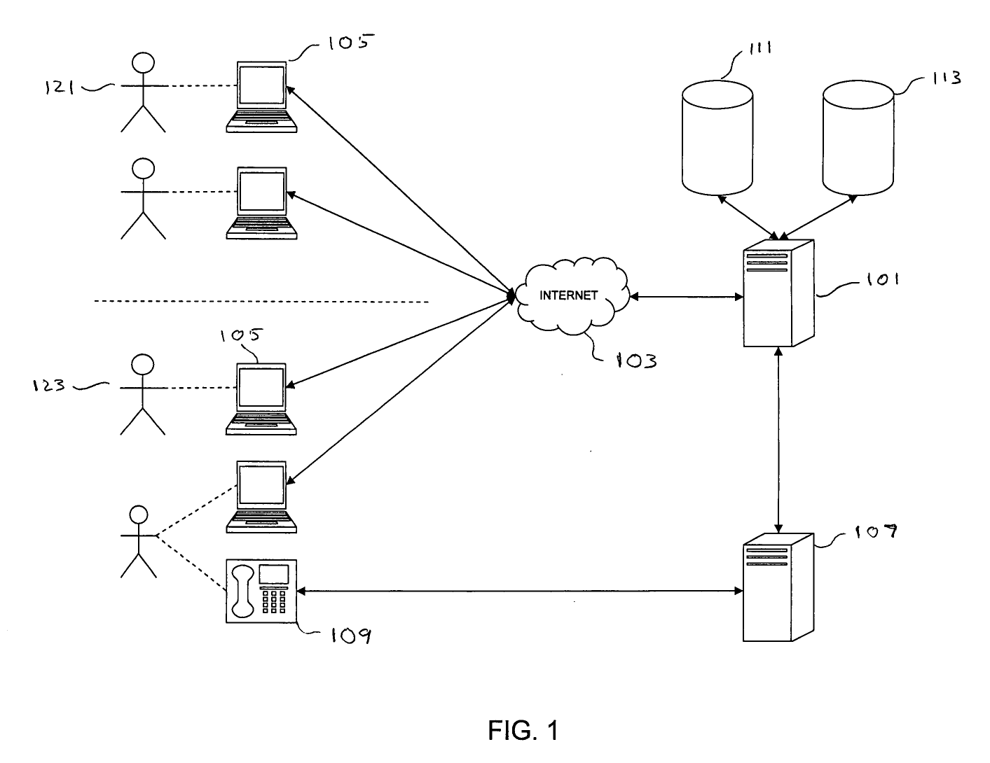

Turning to FIG. 1, in a computer-based system embodiment, a server computer 101 is configured for communication with users including customers 121 seeking to hire a driver, and drivers 123 offering a for-hire driving service.

The customer 121 and driver 123 users communicate with the server computer 101 via a communication interface or network 103 such as the Internet, typically using a computer device or user terminal 105 such as a personal computer, PDA, cell phone, or the like.

An additional communication interface, such as a telecommunication interface or remote call service 107, may be provided. A remote call service 107 may be configured to communicate with a user's telephone, cellular telephone, pager, or other telecommunication device 109, for example by generating a voice message and delivering the voice message to the user's telephone communication device 109 as a reminder or indication of a change in system status to prompt the user to log in to the system to check on a current status.

A system data store comprising one or more data storage elements is provided, maintained by or accessible by the server computer 101. The system data store stores a user database configured to include a plurality of driver profiles and a plurality of customer profiles.

For example, a user database may comprise a customer database 111 and a driver database 113 maintained by, or accessible to, the server computer 101 to store pertinent customer and driver information.

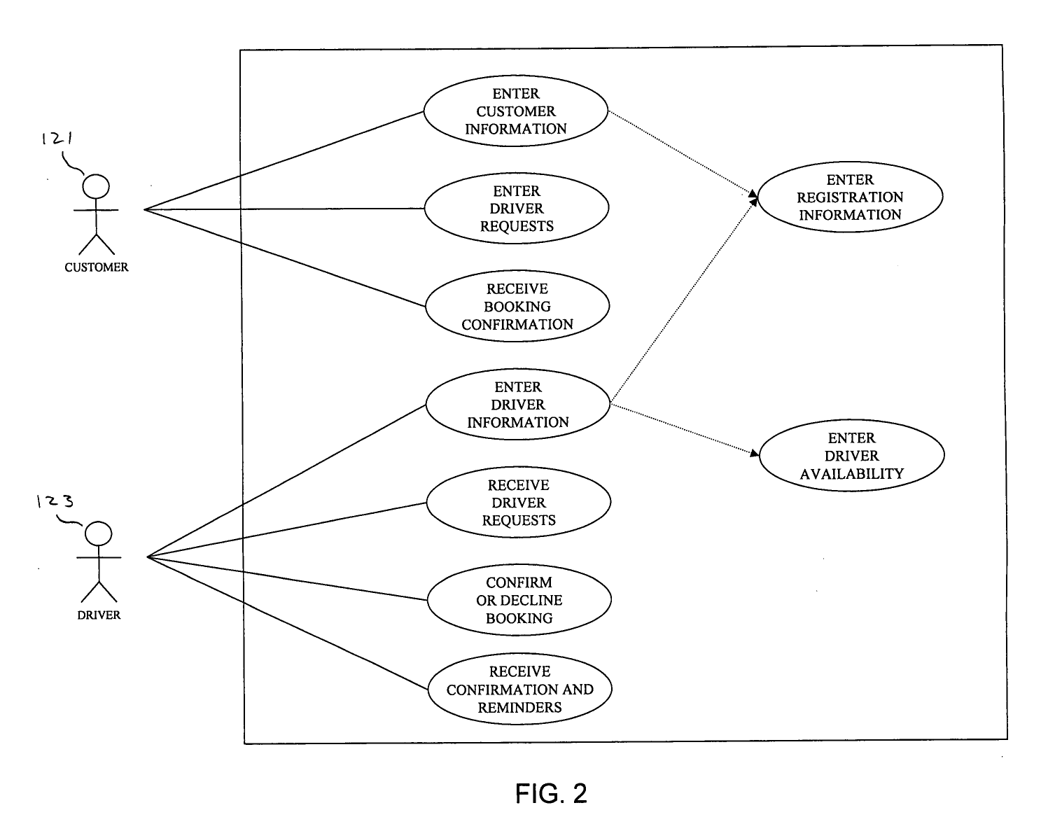

Referring to FIG. 2, registered customers 121 may interact with the system to enter driver booking requests (identifying a time during which a driver is needed) and to receive booking confirmations, or confirmation that a driver has agreed to be hired to fulfill the customer's driver request.

Registered drivers 123 may interact with the system to receive customer driver requests, and to accept or decline to be hired to fulfill the customer's driver request. Registered drivers 123 may also receive confirmation of customer bookings, as well as reminders of pending bookings or other status or change in status.

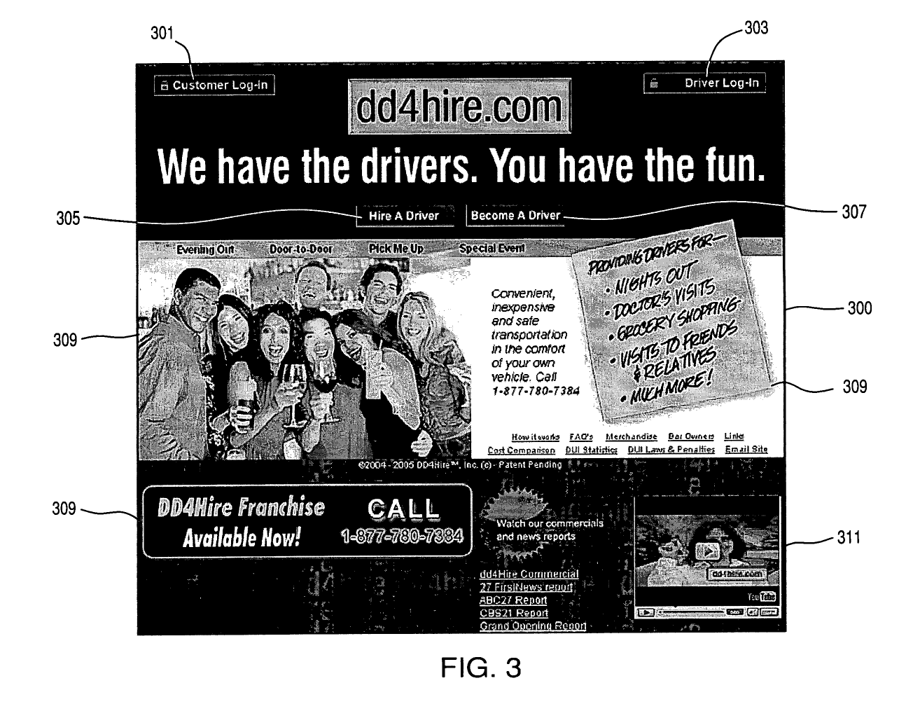

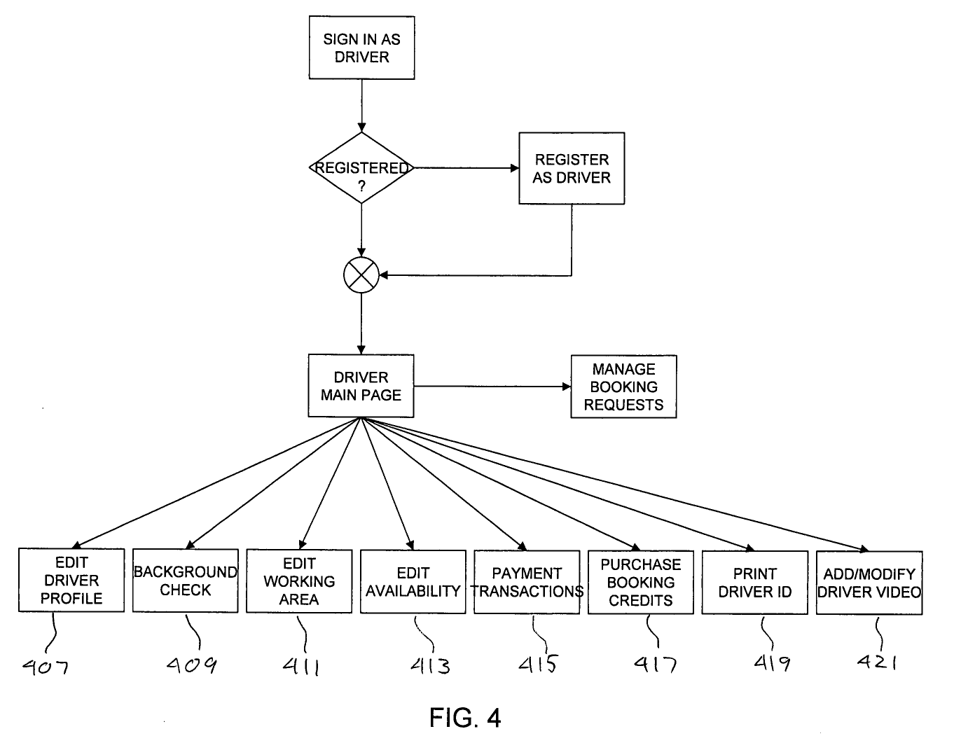

Upon a user's initial access to the system, a user home page 300 is generated for display on the user's terminal 105. One embodiment of a user home page is shown in FIG. 3.

The illustrated user home page 300 includes a customer login control 301, which a user may select to log on as a customer 121, a driver login control 303, which a user may select to log on as a driver 123, a customer registration control 305, which a user may select to register as a customer 121, and a driver registration control 307, which a user may select to register as a driver 123.

The user home page 300 may also include promotional elements such as advertising logo, text, graphics and the like 309, as well as a promotional or informational video 311. The system may store a video clip or file such as an MPEG video file for display on the user home page 300, or may receive and display video content from a remotely hosted video source.

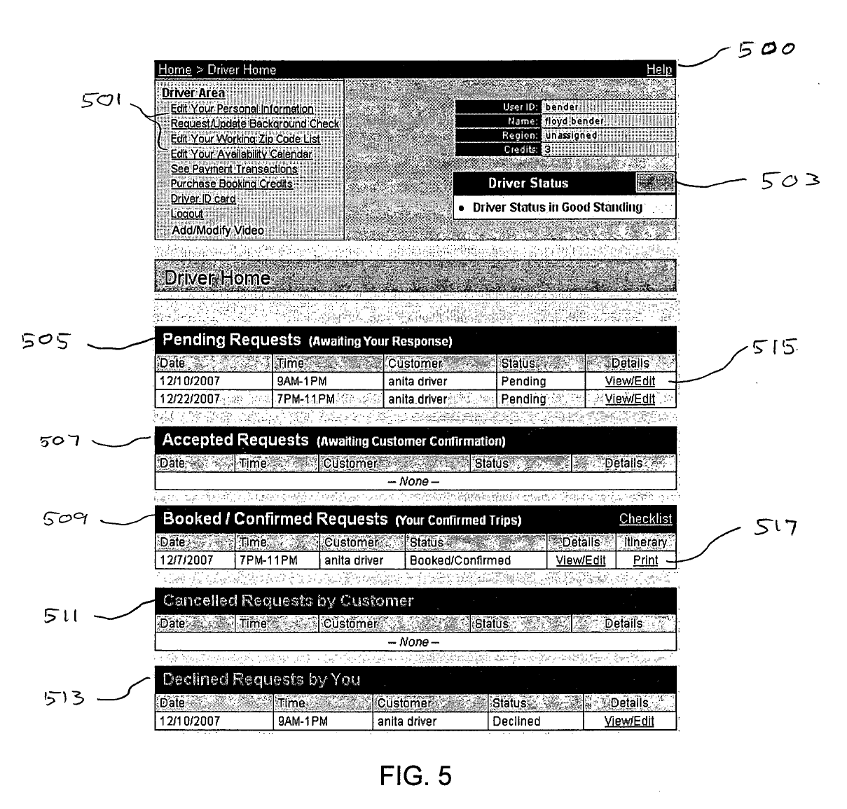

Turning to FIG. 4, certain embodiments of the system provide for driver registration and login. Once logged into the system, a registered driver is presented with a driver home page 500. An example of a driver home page 500 is shown in FIG. 5, including a list of booking requests for the driver and presenting the driver with options for further interaction with the system.

Driver login (at 401) may proceed in a conventional manner for user access to a computer system, such as by requiring the driver to submit a username and password to the system for verification and validation. For example, the system may generate a WEB page or dialog box or the like for delivery to, and display on, a user computer terminal providing for entry of the driver's username and password to the system.

Alternative to the driver sign in, unregistered drivers (those lacking a valid username and password known to the system) may be given the opportunity to register (at 403) by entering relevant personal information including a username and password into the driver database 113.

Upon successful login or registration, a driver home page 500 is generated for display on the driver's user terminal. An embodiment of a driver home page 500 is shown in FIG. 5. The driver home page 500 allows a driver to manage booking requests (at 405) received from customers.

The driver home page 500 also gives the driver access to perform functions such as edit a driver profile (at 407), request a background check (at 409), define or edit a “working area” (at 411), define or edit a driver availability schedule (at 413), conduct payment transactions (at 415), purchase booking credits (at 417), print a driver identification card or document (at 419), add or modify a driver video (at 421) or other functions.

The driver home page 500 includes a plurality of links 501 for navigation to access and perform these or other functions.

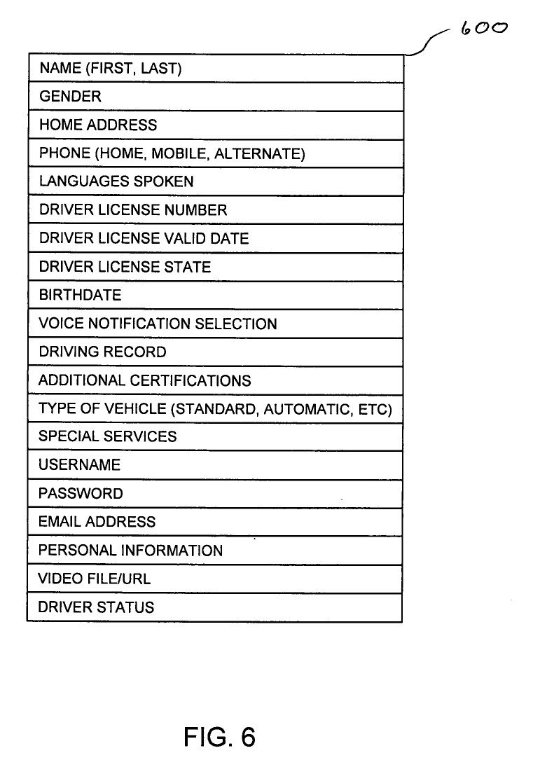

Referring to FIGS. 6-8, a driver profile consists of certain information about the driver stored by the system. In an illustrated embodiment, the driver profile is represented as a data table 600, which may be stored in the driver database 113. Alternatively, the driver profile may include information distributed among several databases or data objects.

Driver profile information may include, for example, driver identification information (such as the driver's name, gender, age or birthdate, address, email address, telephone, and other contact information), as well as driver qualification information (such as driver's license information including license number and state, valid or expiration dates, endorsements or limitations, and the like), and other information that may be helpful to a customer in selecting a driver for hire (such as language fluency, special services the driver is willing or able to perform, additional personal information, and the like).

The driver profile may also designate contact information such as a telephone number to be used by the system to deliver automated voice or other notifications to the driver, such as a voice notification to alert the driver of a new booking request.

A driver may also provide a video clip to be displayed to customers who wish to consider hiring the driver. For example, a short video clip, such as an MPEG (Moving Picture Experts Group) video file, may be uploaded to, and stored by, the system.

Alternatively, the driver may provide an Internet or World Wide Web address or link, such as a Uniform Resource Locator (URL), for accessing a remotely hosted video for display by the system.

In addition, or alternative, to the video clip or URL, the driver may upload a photograph to the system to be included with the driver profile.

The driver profile may also include a driver status or eligibility indication (generally not modifiable by the driver, but set by the system) indicating whether a registered driver is eligible to receive and accept booking requests.

For example, before a registered driver is considered to be eligible to receive and accept customer booking requests, the driver may be required to obtain an online background or security check, and may be required to renew the background or security check annually.

The system may be configured to receive a driver request to obtain a background or security check, and to forward a background or security check request to a commercial background or security check provider and receive a report.

Advance payment may be requested and received from the driver prior to obtaining the background or security check report, using conventional electronic or Internet-based consumer payment methods or services.

Also, the driver may be required to purchase booking credits, wherein a booking credit is tendered as a service fee to a system operator for every booking request that is accepted.

A driver status indicator 503 may be provided on the driver home page 500, providing the driver an indication as to whether the driver is currently eligible to receive and accept booking requests. If the driver status indicator 503 indicates an in eligible status, then the driver must purchase additional booking credits, update the background check, or take other action to regain eligibility.

The system may designate a driver to be ineligible upon the occurrence of certain predetermined events. For example, an eligible driver may become ineligible when the driver's booking credits are used, when the driver's availability calendar does not indicate any available dates, when the driver's background check expires, or the like.

In certain embodiments, an automatic notification (such as a telephone voice message or email message) may be generated and sent to the driver to indicate a change in eligibility status. Thus, drivers are quickly made available of any situation that could prohibit a driver from receiving booking requests.

Initially, information for the driver profile may be collected during a driver registration process, during which a registering driver is prompted to enter personal information or other information that is required for, or related to, offering the driver's services for hire.

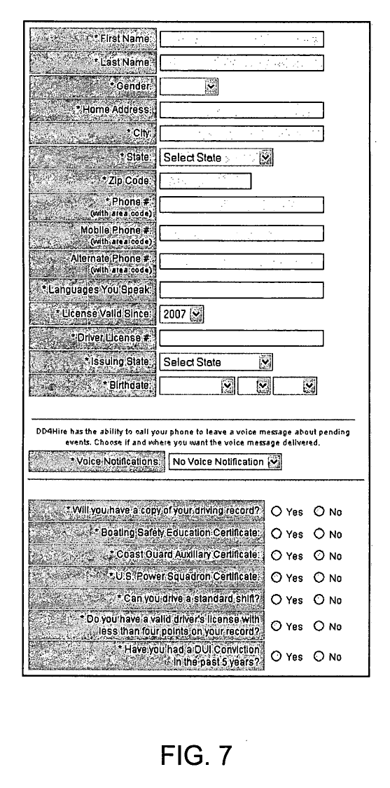

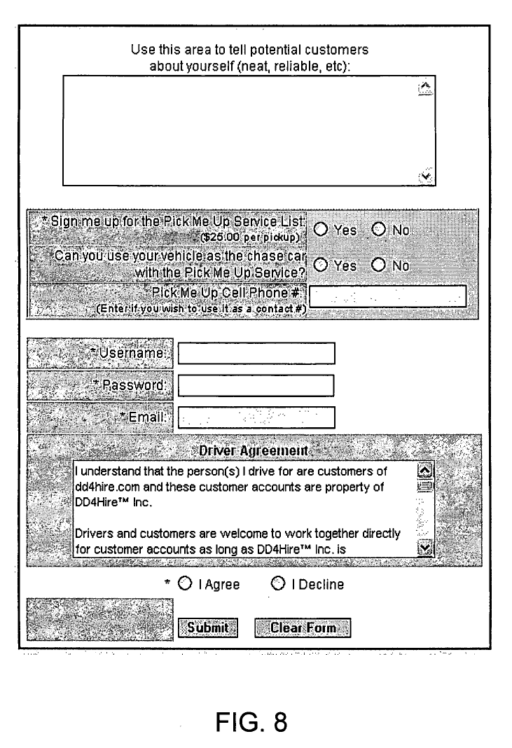

For example, the system may generate user interface forms such as seen in FIGS. 7 and 8 to prompt a driver to enter profile information.

Further, once registered, a registered driver may access the driver's profile to review, edit or update the driver's profile information.

A registered driver may define a service area, or a geographic area in which the driver is available to provide services.

For example, in certain embodiments a driver may enter a list of postal zip codes to define a service area. Alternatively, the driver may enter a single zip code or geographical location along with a radius defining an area in which the driver is willing to work.

With driver service areas defined by zip codes in which a driver agrees to provide service, customers may enter pick-up and drop-off zip codes to filter a list of available drivers, identifying those drivers with a service area that encompasses the customer pick-up and drop-off points.

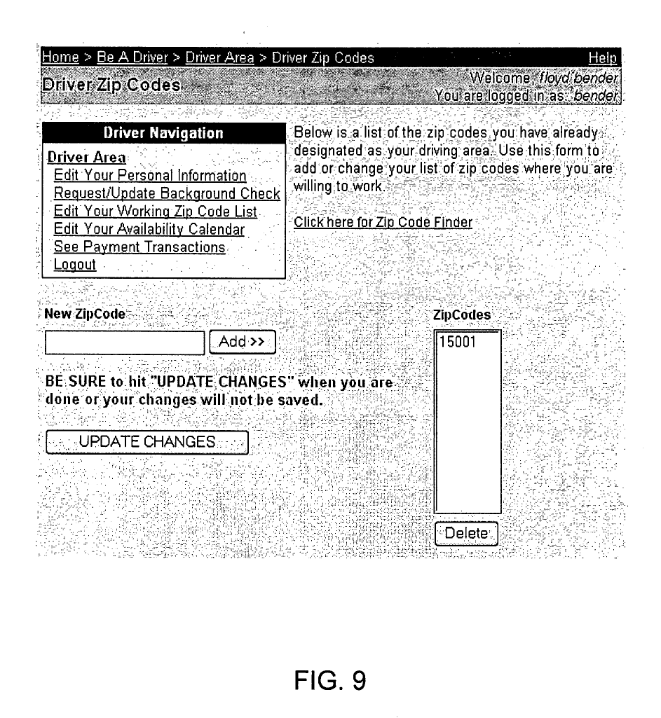

Referring to FIG. 9, an example display screen is shown for entry or modification of a driver's service area zip code list.

In addition to defining a service area, drivers may enter available times in an availability calendar, indicating days and times that the driver is available for hire. Driver availability times and days are stored by the system in the driver database 113.

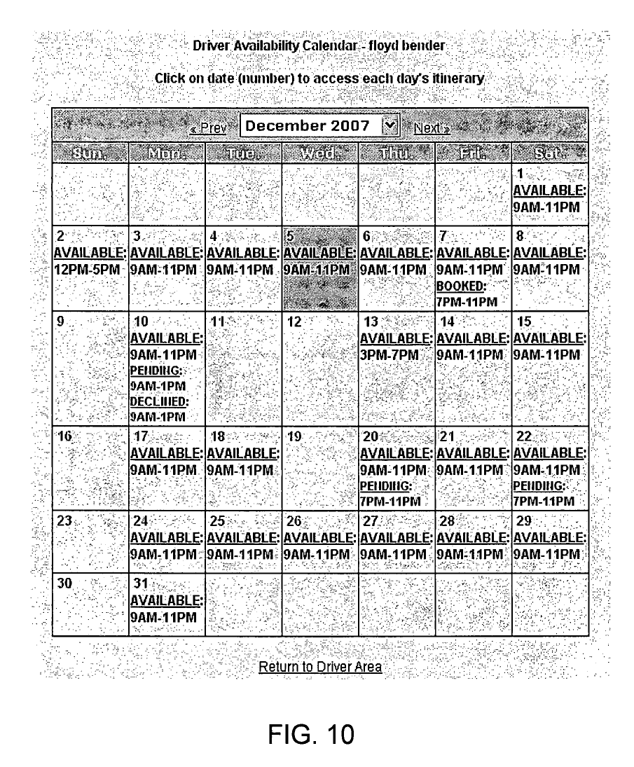

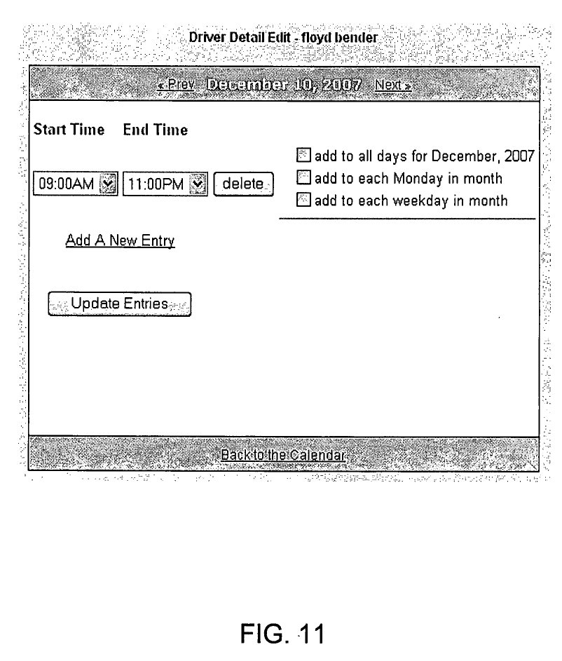

Referring to FIGS. 10 and 11, a driver availability calendar is shown (FIG. 10) along with an example of a dialog entry user interface for entering or updating driver availability information (FIG. 11).

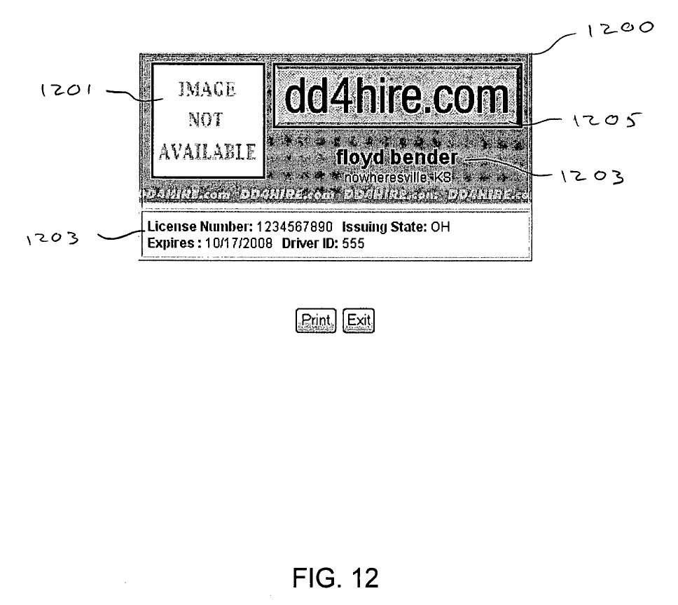

Turning to FIG. 12, the system may create an identification (ID) card 1200, including a photo 1201, licensing and other personal information 1203, as well as a logo 1205 or other identifier of a service provider. The ID card 1200 is forwarded to a driver's user terminal, where the driver can print a hard copy of the ID card 1200.

The ID card 1200 is provided to a registered driver 123 to be presented to a customer upon customer pick-up, for providing verification that the driver 123 is a qualified driver 123 registered in the system.

Registered customers 121 may interact with the system to identify available drivers, make booking requests, and to confirm a driver's acceptance of a booking request.

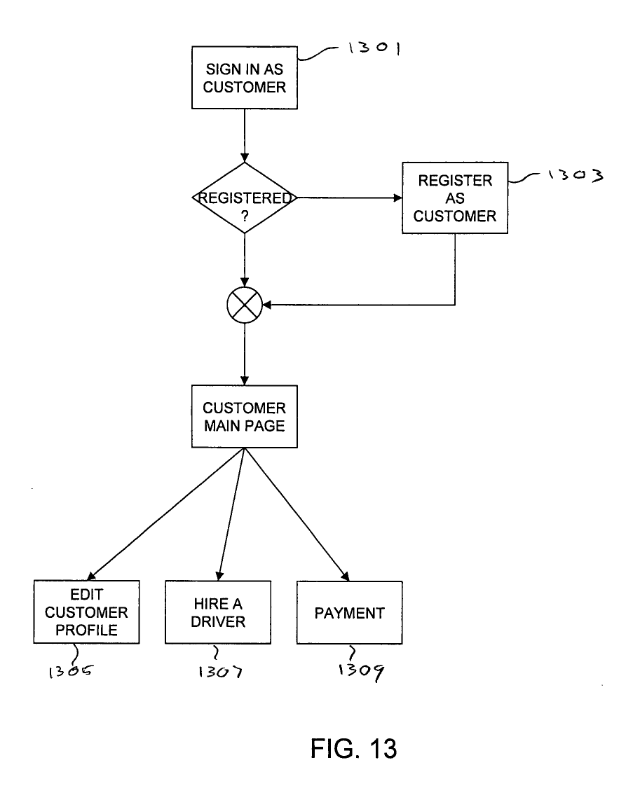

Turning to FIG. 13, certain embodiments of the system provide for customer registration and login, similar to the driver registration and login described above.

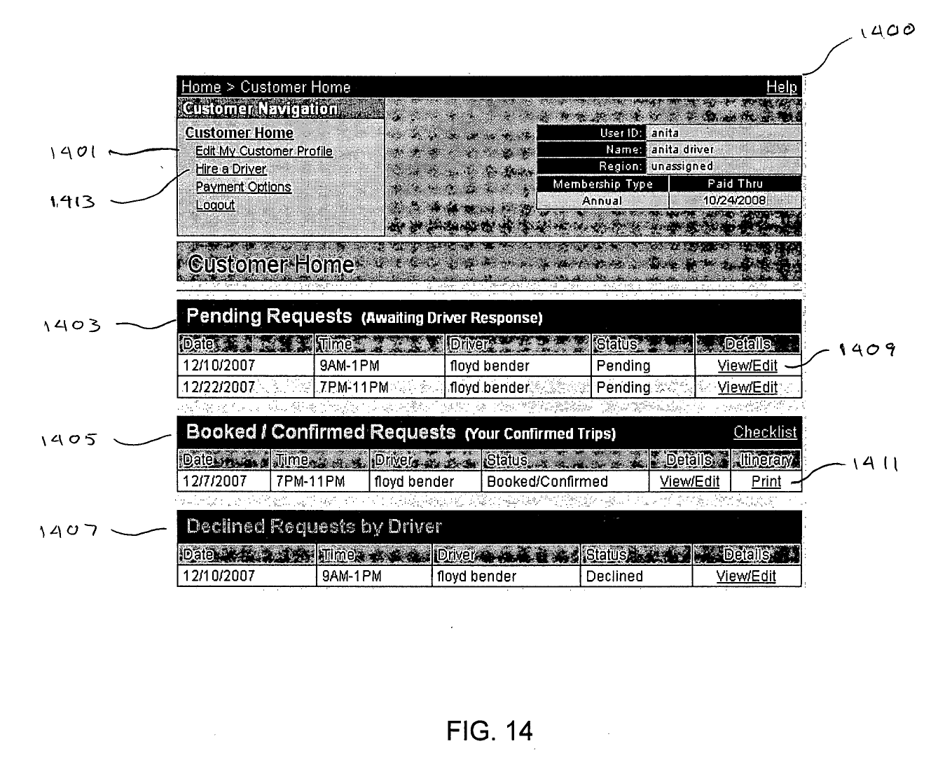

Once logged into the system, a registered customer is presented with a customer home page 1400 (see FIG. 14) that presents the customer with options for further interaction with the system.

Customer login (at 1301) may proceed in a conventional manner for user access to a computer system, including submission of a username and password for verification and validation, as in the driver login described above.

Alternative to the customer login, unregistered customers (those lacking a valid username and password known to the system) may be given the opportunity to register (at 1303) by entering relevant personal information including a username and password.

Upon successful login or registration, a customer home page 1400 is generated for display on the customer's user terminal (seen in FIG. 14). The customer is given access to functions such as editing a customer profile (at 1305), entering and managing booking requests to hire a driver (at 1307), conducting payment transactions (at 1309), or other functions.

The customer home page 1400 includes links 1401 for navigation to access the available functions. The customer home page 1400 also includes a list of pending 1403, confirmed 1405, or declined 1407 booking requests. Each listed booking request may also include a link or control that the customer may select to view details of the request 1409, to print the request or an itinerary 1411, or other functions.

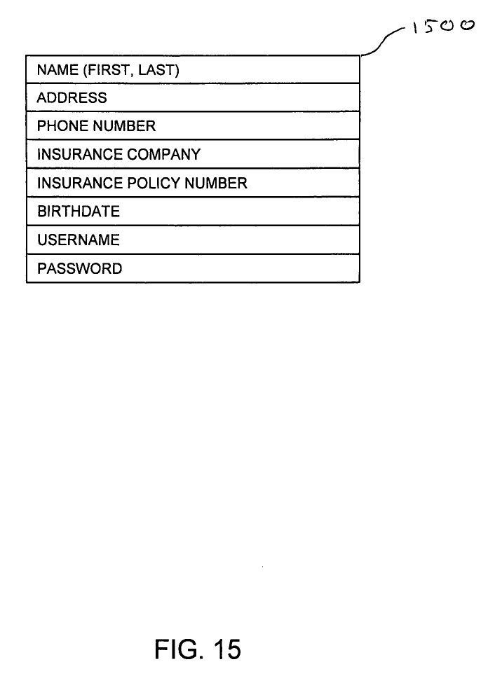

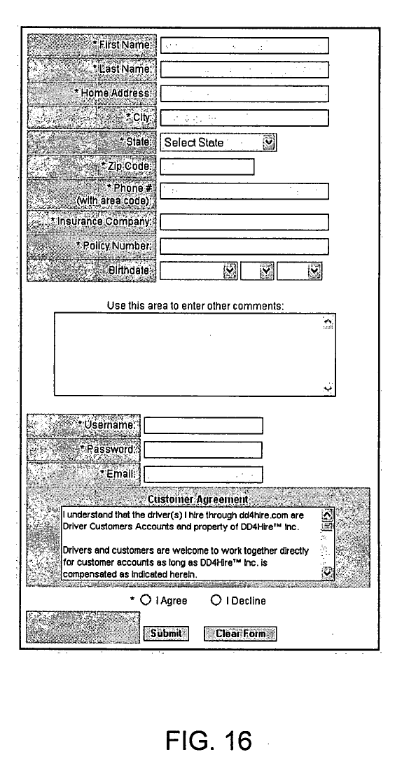

Referring to FIGS. 15 and 16, a customer's profile consists of certain information about the customer stored by the system. In an illustrated embodiment, the customer profile is represented as a data table 1500, which may be stored in a system customer database 111. Alternatively, the customer profile may include customer information distributed among several databases or data objects.

Customer profile information may include, for example, customer identification information (such as the driver's name, gender, age or birthdate, address, email address, telephone, and other contact information), as well as customer vehicle insurance information (such as an insurance company and policy number associated with the customer's vehicle). The customer profile may also include additional personal information about the customer or customer preferences or comments relevant to a driver's decision to accept booking requests made by the customer.

Registered customers may enter booking requests to identify drivers that are available for hire according to the drivers' availability schedules and working areas.

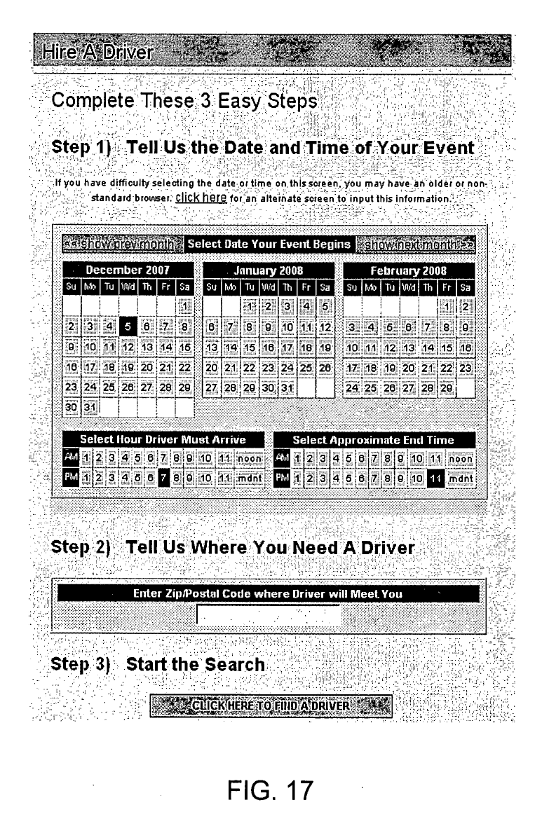

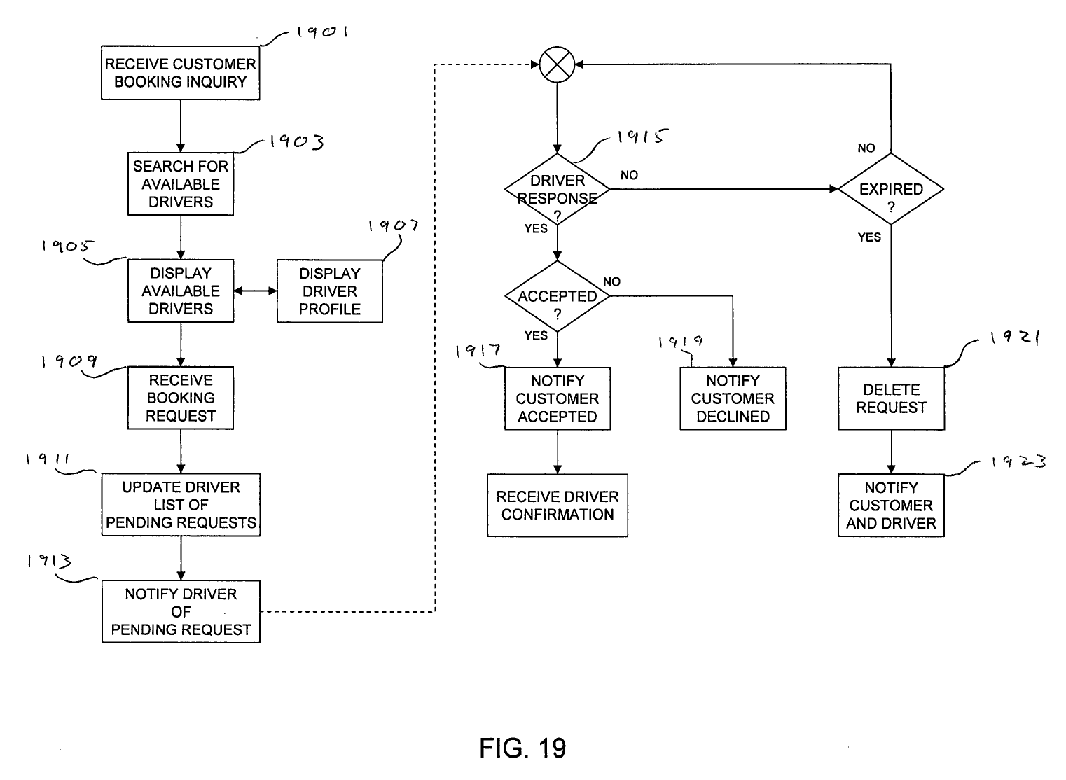

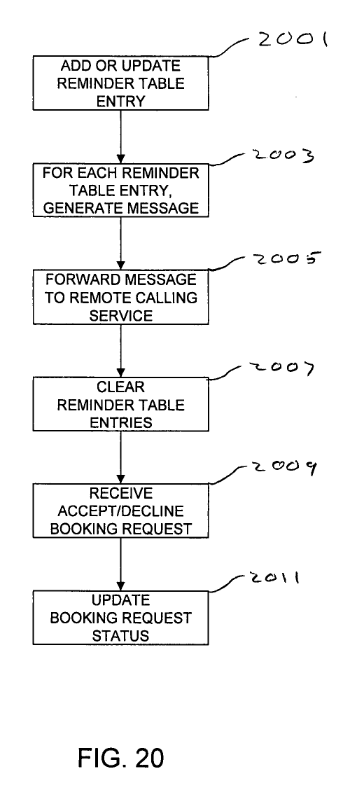

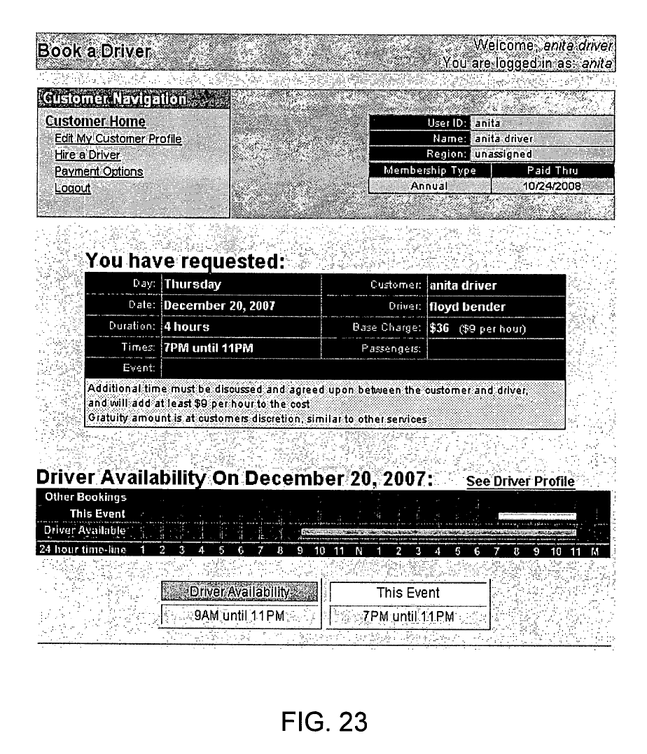

Referring to FIGS. 17-26, a process for receiving and processing customer booking inquiries and requests described.

Once a customer elects to hire a driver (such as by clicking on a “hire a driver” link or control 1413 on the customer home page 1400), the customer is provided with a driver request display to allow entry of a booking inquiry (step 1901), such as shown in FIG. 17.

The customer enters a booking inquiry by entering a date and time period for which the customer desires to hire a driver, along with a zip code or other geographic information indicating where the driver services are needed, and the booking inquiry is submitted to the system.

Upon receipt of the customer's booking inquiry, the system performs a search of driver availability and service area data to identify registered drivers who are available for hire during the requested time and whose working area includes the customer's requested area or location (step 1903).

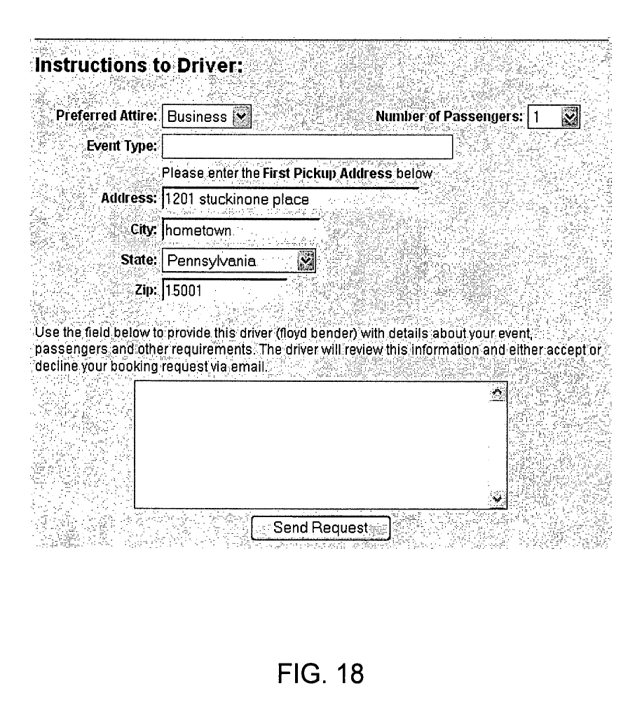

In certain embodiments, referring to FIG. 18, the system may provide the customer with an instruction entry form 1800 to provide additional instructions or comments to a driver. The instruction entry form 1800 may include, for example, an indication of preferred attire for the driver, an entry for the type of event, an entry for the number of passengers, a pickup address, as well as a text entry box for entry of additional comments or instructions for the driver.

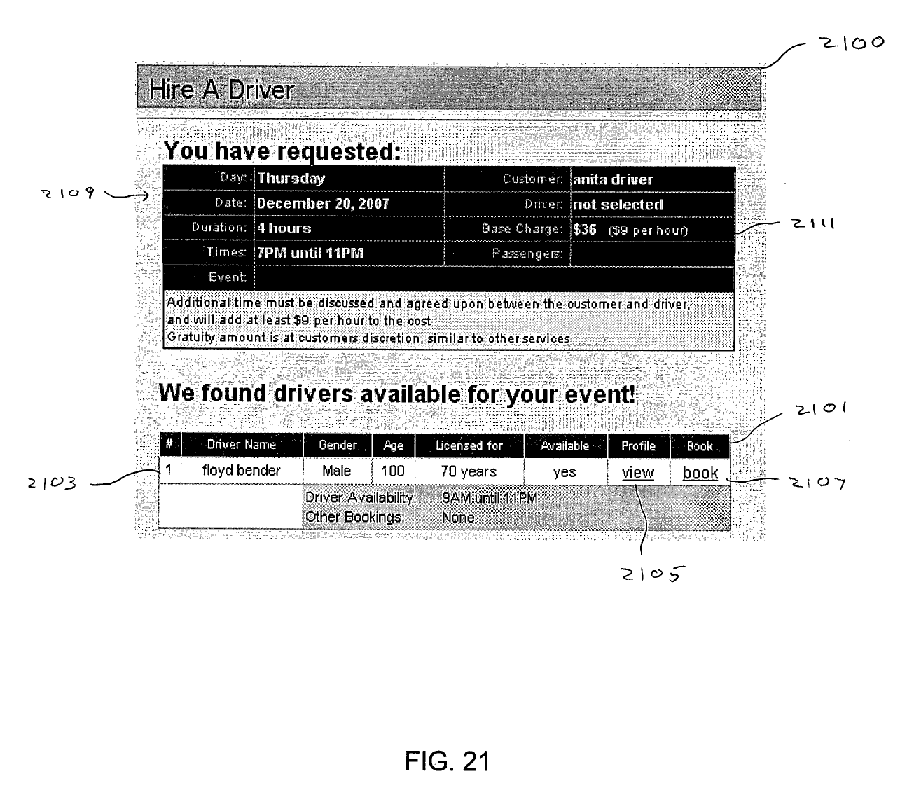

Referring to FIG. 21, a list 2101 of available drivers is generated for display to the customer in response to the customer's inquiry (step 1905). For each driver entry 2103 in the list 2101, a profile link 2105 may be provided which the customer may select to view the driver's profile, and a booking link 2107 may be provided which the customer may select to enter a booking request for the driver.

Additionally, summary information 2109 of the request is displayed, along with the cost 2111 for booking a driver 123 to service the request.

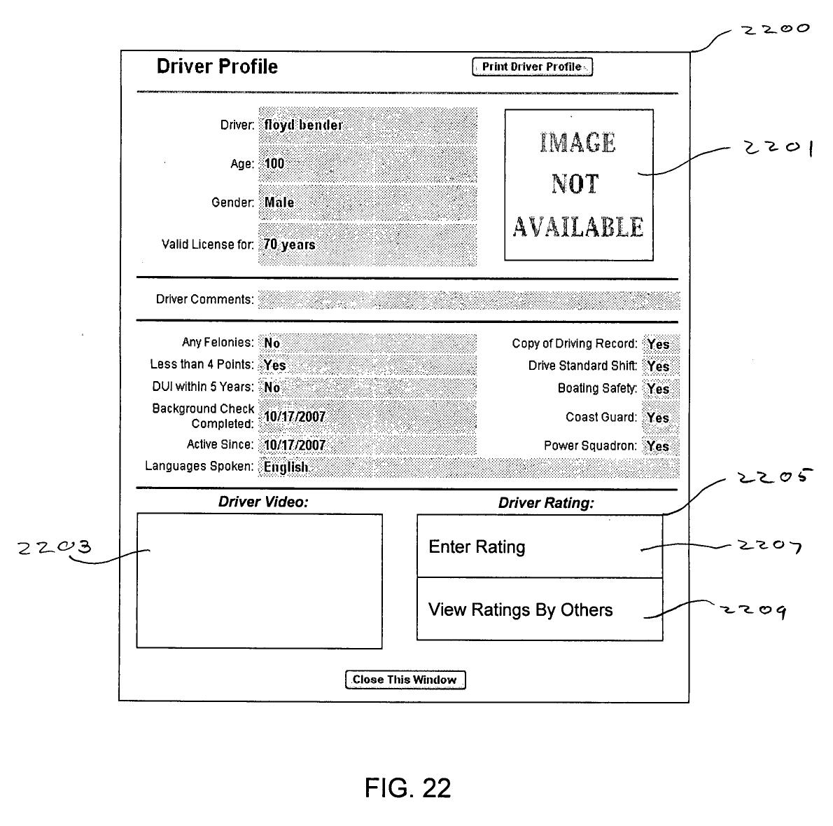

Upon selection of the profile link 2105 for a driver, a driver profile display 2200 is generated and forwarded to the customer's user terminal for display (see FIG. 22), such that the customer may review the driver's profile prior to making a booking request (step 1907).

The driver profile display 2200 may include profile information such as the driver's name, licensing information, a photograph 2201 of the driver, a summary of the driver's background check or driving record, and other information that may be relevant to the driver's evaluation of the driver.

In certain embodiments, the driver profile display 2200 includes a video display field 2203 in which the driver's video is displayed. Thus, a customer may evaluate the driver's appearance, mannerisms, and other characteristics that may be well presented in a video format prior to making a hiring decision.

In certain embodiments, the driver's profile display 2200 includes a driver rating field 2205. The driver rating field 2205 may include an entry dialog box 2207 or the like for entry of a driver rating (such as a rating on a 1-5 scale of bad to good impressions) and customer comments. Additionally, the driver rating field 2205 provides the customer with a view 2209 of driver ratings submitted by other customers 121.

Thus, drivers 123 receive, and customers 121 may view, publicly submitted feedback about drivers 123 and their service provided. Customers 121 may view driver ratings prior to booking, or enter driver ratings after having hired a driver and used the driver's services.

In addition to displaying driver rating information along with the driver profile, a separate forum may be provided for driver ratings, including provisions for a driver reply to customer comments. Preferably, the driver is not allowed to edit or remove either customer comments or ratings. However, a system administrator may be provided with a capability to edit or remove customer comments and ratings.

Once a customer has selected a driver to hire, the customer may enter a booking request (step 1909).

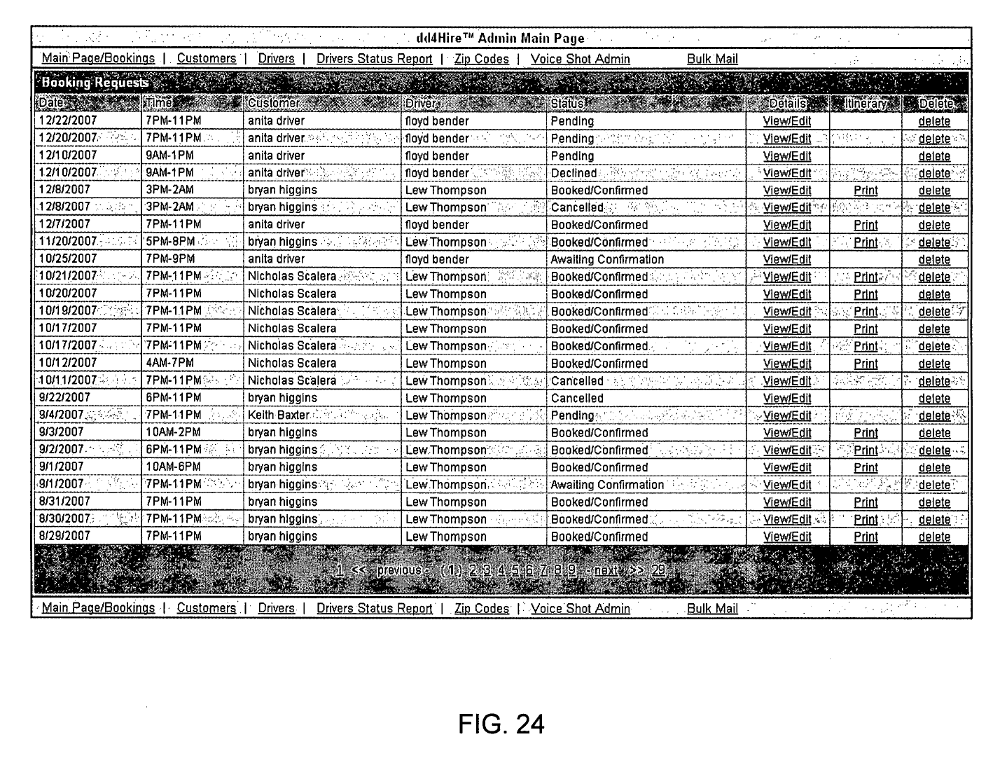

Upon receipt of the customer's booking request, the booking request is stored by the system, for example in a booking request list or table 2400 (seen in FIG. 24) in a database accessible to or maintained by the system.

The booking request list or table 2400 includes information about each booking request, such as the date and time of the booking, the customer, the driver, and the present status of the request (such as pending, accepted, confirmed, declined, cancelled, or the like).

Additionally upon receipt of the customer's booking request, the system generates a notification message and forwards the notification message to the driver (step 1913), to alert the driver to the new pending booking request.

Notification messages are sent to the driver in the form of a voice message, automatically generated and delivered to the driver's telephone. Alternatively, the notification message may be sent in the form of a text message delivered to the driver's telephone, pager, PDA, or other telecommunication device.

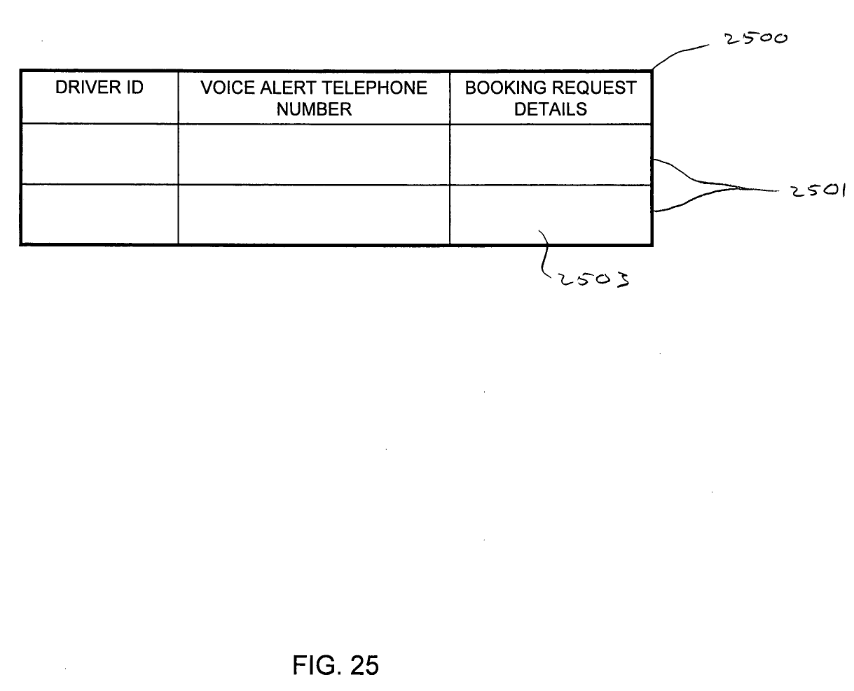

In one embodiment, when a new booking request is received an entry 2501 is made in a reminder table 2500 (seen in FIG. 25) for a scheduled reminder process periodically executed by the system. Thus, as customers place booking requests for a driver, a new reminder entry 2501 is added, or and existing reminder entry 2501 updated, in the reminder table 2500 for the driver (step 2001).

A scheduled process is automatically started by the system to periodically scan the reminder table 2500. For each reminder entry 2501 in the reminder table 2500, a request is generated (step 2003) and sent to a remote call service 107 (step 2005).

The reminder table 2500 may be configured and maintained to include only a single entry 2501 for each driver, regardless of the number of new booking requests received for the driver, in order to avoid generating an excessive number of multiple reminders for the single driver. Alternatively, in certain embodiments a unique entry 2501 may be generated for each unique booking request, such as in embodiments wherein a reminder telephone call is interactive to allow driver acceptance of a booking request.

The reminder may include a textual message, which will be translated into a voice message by the remote call service 107. The reminder also includes the driver's telephone number designated to receive the telephonic reminder.

The remote call service 107 receives the request, and translates the textual message into a voice message. The remote call service 107 dials the driver's telephone number, and plays the voice message.

Once a call request has been processed, the reminder entry 2501 in the reminder table 2500 is removed (step 2007). Additionally, a pending reminder entry 2501 for a driver may be removed from the reminder table 2500 when the driver logs into the system and views new booking requests, since once the driver has viewed new requests, the telephonic notification is not necessary.

In certain embodiments, the telephone reminder messaging process may further allow a driver to accept or decline a new booking request during the course of the reminder telephone call (step 2009). For example, a reminder entry 2501 may include booking request details 2503 which may be included in the telephone message.

During a reminder telephone call, the driver may use keys on the telephone (for example press #1 to accept, press #2 to decline) or voice commands to accept or decline a booking request. In such an embodiment, upon receipt of the driver's accept/decline indication, the status of the booking request is updated accordingly by the system (step 2011).

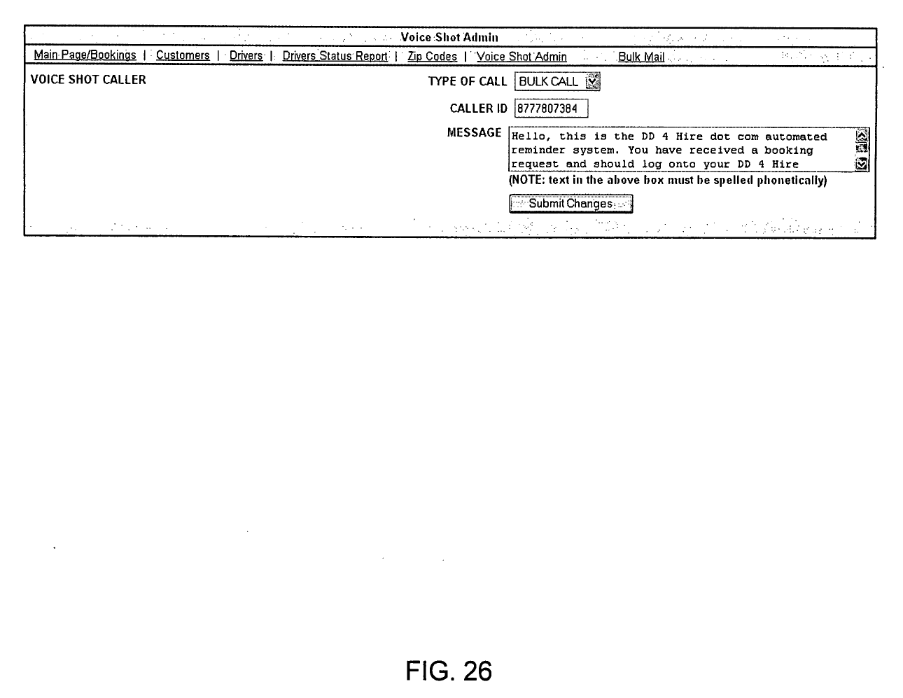

Referring to FIG. 26, the system is configured to generate an entry form whereby a system administrator or other user may be given access to configure aspects of the automatic telephonic reminder feature, such as entering or modifying message text.

Returning to FIG. 5, as booking requests for a driver are received, accepted by the driver, confirmed by the customer, and so forth, the booking requests are displayed on the driver home page 500 according to their status, as drivers log in to the system.

In the illustrated embodiment, the driver home page 500 includes a separate list for new pending requests 505 (new requests received and not yet accepted or declined by the driver), accepted requests 507 (requests accepted by the driver but not net confirmed by the customer), and confirmed requests 509 (requests that have been accepted by the driver and confirmed by the customer).

Additionally, the driver home page may include a list of cancelled requests 511 (requests cancelled by the customer), and declined requests 513 (requests declined by the driver).

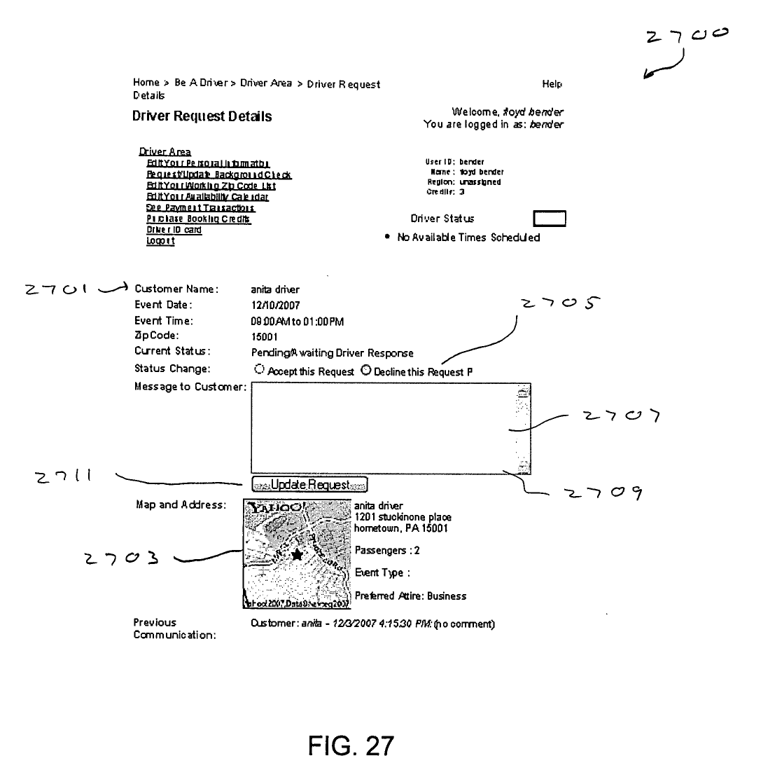

For each of the listed requests, an edit/view control 515 is provided to allow the driver to edit or view the request. For example, referring to FIG. 27, a summary view 2700 of a request may be generated by the system for a driver's review, such as prior to the driver's acceptance of the request, upon confirmation of the booking, or at another time for the driver's convenience.

The summary view 2700 includes the name and contact information 2701 for the customer, booking request details such as the date, time, and pickup location of the request. Additionally, the summary view may include a map 2703 to the customer's pick-up location.

If the summary view 2700 is displayed for a pending request, an accept/decline control 2705 may be displayed to allow the driver to accept or decline the request. If the summary view 2700 is displayed for a confirmed (booked) request, the accept/decline control 2705 may be omitted. Alternatively, inclusion of the accept/decline control 2705 allows a driver to cancel an already accepted and confirmed request.

Upon receipt of a driver's booking response (step 1915) (either accepting or declining the booking request), the customer 121 is notified of the driver's response (steps 1917, 1919). In certain embodiments, if the driver 123 does not accept or decline a booking request within a predetermined interval, the system will automatically decline the request (step 1921) and notify both the customer and driver of the action (step 1923).

The summary view 2700 may include a text entry control 2607 for entry of a message to the customer, and a message log 2709 displaying a message history of communications between the driver 123 and customer 121 regarding the request. Thus, the driver 123 and customer 121 may exchange messages prior to the driver's acceptance of the booking request.

An update control 2671 allows the driver to submit messages, or to submit the driver's acceptance or refusal of the booking request.

For each confirmed request 509 shown on the driver home page 500, a print control 517 is provided to allow the driver to print out the request, the summary view 2700, or an itinerary associated with the request.

Upon completion of a booking request, customer payment may be completed. In certain embodiments, customer payments may required for each individual booking or service. Alternatively, a subscription option may be employed, such as offering unlimited service for a fixed monthly fee.

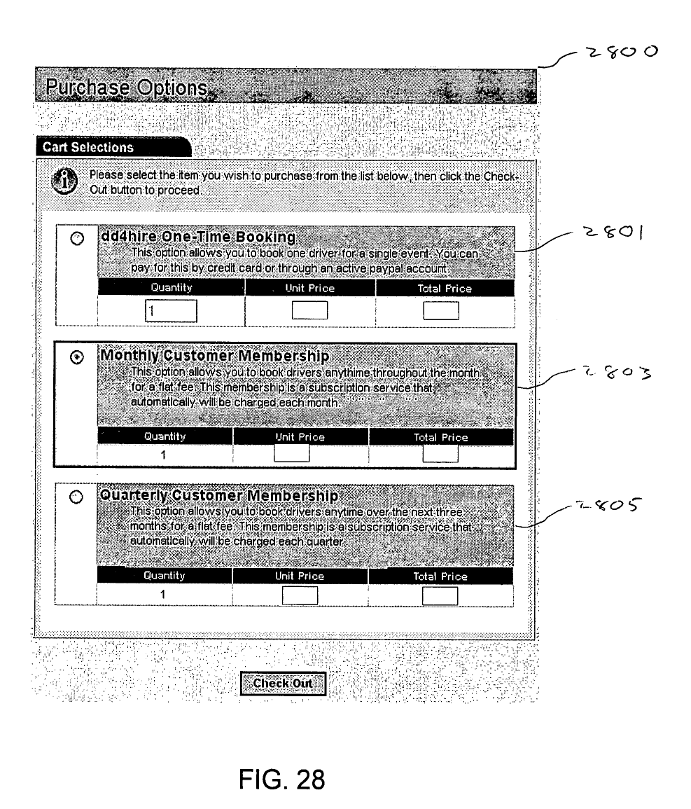

Referring to FIG. 28, one embodiment of a payment option display 2800 is shown, offering a single-event payment option 2801, as well as a monthly 2803 and a quarterly 2805 subscription option. Other arrangements may be made as well.

Payments may be made by well known electronic or on-line means, such as by credit card, use of an Internet or on-line payment service provider such as PayPal, or another electronic commerce payment solution. Alternatively, electronic check payments may be accepted by prompting a user to enter a checking account ABA routing number and checking account number.

An entry form may be provided to users for entry of payment information, including a payment type, account information, and amount.

Upon receipt of the user's payment information, the system will automatically connect with an appropriate payment service provider and conduct a payment transaction according to the customer's indicated method of payment and account information.

Similar payment methods may be employed for driver purchase of booking credits.

In the system embodiment of FIG. 1, as previously discussed, the system comprises a server computer 101 connected to a network 103 such as the Internet such that the server computer 101 is accessible by, and communicates with, one or more user terminals 105 via the network 103.

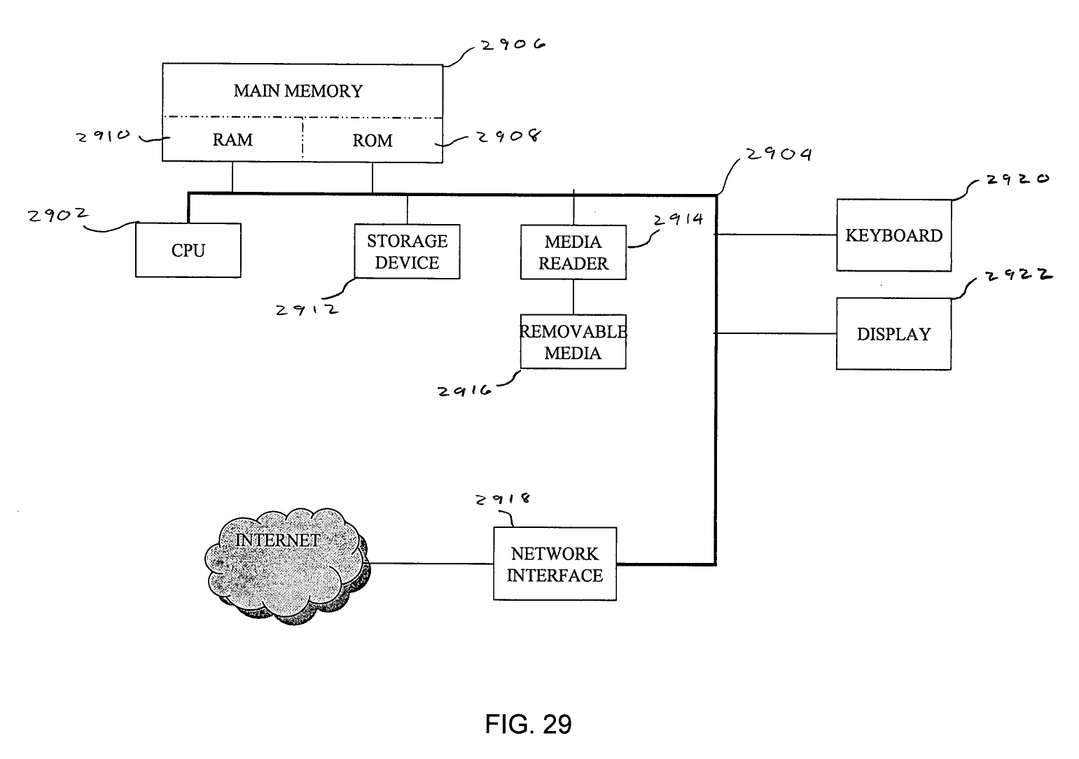

Computer devices such as the server computer 101 and the user terminals 103 generally (but need not) correspond to a typical architecture as shown in FIG. 29.

In such an architecture, a central processing unit (CPU) 2902 includes, or is connected by a bus 2904 to, an area of main memory 2906, comprising both read only memory (ROM) 2908, and random access memory (RAM) 2910, and a storage device 2912 such as a disk storage device having means for reading a coded set of program instructions on a computer readable medium which may be loaded into main memory 2906 and executed by the central processing unit (CPU) 2902. Additional storage devices may be provided, such as a media reader 2914 for reading a removable storage media 2916 such as a removable disk drive, CD-ROM drive, DVD drive, memory card, USB memory device, or the like.

The computer device includes at least one communication interface 2918 for communicating with another computer device or network device, such as a network interface, a modem, or any other device for establishing communications with another computer device or network device.

A keyboard 2920 and display 2922, or other input/output or user interface devices, are typically provided for user interaction with computer devices such as the user terminals 105. On the other hand, such input/output or user interface devices may be omitted from a server computer such as server computer 101 wherein user interaction may be restricted to network accessibility.

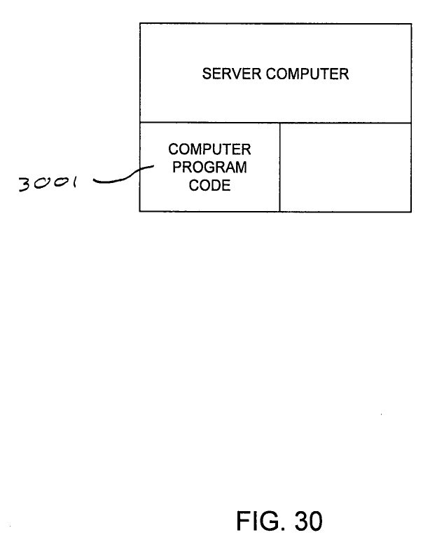

Referring to FIG. 30, computer program code 3001 is provided in or to the server computer such that the server computer is programmed or adapted to perform the methods and functions described above.

It will be understood that the above-described embodiments of the invention are illustrative in nature, and that modifications thereof may occur to those skilled in the art. Accordingly, this invention is not to be regarded as limited to the embodiments disclosed herein, but is to be limited only as defined in the appended claims.

I claim:

1. A computerized system for matching drivers with customers seeking to hire a driver, the system comprising:
a. a server computer in communication with a communication interface whereby the server computer is accessible by at least one user terminal; and
b. a system data store configured for storing user data including a plurality of driver profiles and a plurality of customer profiles;
wherein said server computer comprises at least one processing element programmed or adapted to:
i. receive a customer booking inquiry from a customer;
ii. determine and deliver to said customer a list of available drivers corresponding to said booking inquiry;
iii. receive a new booking request selecting one of said available drivers, and add said new booking request to a pending booking request list for said selected driver; and
vi. generate and forward to said selected driver a notification message indicating receipt of said new booking request.

2. The system according to claim 1, wherein said processing element is further programmed or adapted to deliver to said driver said pending booking request list, and receive from said driver an indication of the driver's acceptance or refusal of at least one booking request on said booking request list.

3. The system according to claim 1, wherein said processing element is further programmed or adapted to deliver to a customer a list of accepted booking requests.

4. The system according to claim 1, wherein said processing element is further programmed or adapted to deliver to a customer a driver profile for any driver on said list of available drivers.

5. The system according to claim 4, wherein said driver profile includes a video viewable by said customer.

6. The system according to claim 1, wherein said notification message is a voice message sent to a user telephone.

7. The system according to claim 6, wherein said processing element is further programmed or adapted to receive in response to said notification message an indication of the driver's acceptance or refusal of at least one booking request identified in said notification message.

8. The system according to claim 1, wherein said notification message is a textual message sent to a user telephone.

9. The system according to claim 8, wherein said processing element is further programmed or adapted to receive in response to said notification message an indication of the driver's acceptance or refusal of at least one booking request identified in said notification message.

10. The system according to claim 9, wherein the driver's acceptance or refusal of at least one booking request identified in said notification message is received by said server in a message originated from a user's telephone.

11. The system according to claim 1, wherein said new booking request is automatically declined after a predetermined time period elapses without receiving an indication of the driver's acceptance or refusal of said new booking request.

12. The system according to claim 1, wherein each said a driver eligibility status is associated with each registered driver, and the eligibility status is determined according to predetermined eligibility criteria.

13. The system according to claim 12, wherein said processing element is further programmed or adapted to set said driver eligibility indication to an eligible status upon satisfaction of said predetermined eligibility criteria.

14. The system according to claim 12, wherein said processing element is further programmed or adapted to set said driver eligibility indication to an ineligible status when said predetermined eligibility criteria is not satisfied.

15. The system according to claim 12, wherein said processing element is further programmed or adapted to generate and forward to a driver a driver status notification message upon a change in the driver's eligibility indication.

16. The system according to claim 13, wherein said list of available drivers includes only drivers having said eligible status.
